(19) United States
(12) Patent Application Publication
(10) Pub. No.: US 2010/0070451 A1
(43) Pub. Date: Mar. 18, 2010

(54) METHOD OF AUTOMATIC DRIVING OF A TELECOMMUNICATIONS NETWORK WITH LOCAL MUTUALIZATION OF KNOWLEDGE

(76) Inventor: Louis Hugues, Paris (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/306,922

(22) PCT Filed: Jul. 5, 2007
(86) PCT No.: PCT/EP07/56835

§ 371 Date: Dec. 29, 2008

(30) Foreign Application Priority Data
Jul. 5, 2006 (FR) 06/06101

(51) Int. Cl. G06N 5/02; G06F 9/44; G06F 9/46

(52) U.S. Cl. 706/49; 719/331; 719/319

(57) ABSTRACT

The invention relates according to a first aspect to a method of driving a telecommunications network comprising equipment responsible for carrying out network control tasks, each item of equipment comprising a knowledge base intended for storing, in the form of elements dubbed knowledge, contextual information required in order for the equipment to carry out the control tasks for which it is responsible, the method being characterized in that: a logical neighbourhood is defined, consisting of network equipment—intended to cooperate in order to carry out one and the same control task; the knowledge stored in the various knowledge bases is mutualized in the logical neighbourhood, by implementing for each item of equipment of the logical neighbourhood a cooperation of said item of equipment with the other items of equipment of the logical neighbourhood; in each item of equipment of the logical neighbourhood, the same control task is carried out by feeding it with the mutualized knowledge stored in the knowledge base of said item of equipment. The invention extends also to an item of equipment, and to a network comprising means for implementing the method according to the first aspect of the invention.

The field of the invention is that of the automatic driving of a telecommunications network.

The invention relates more precisely to a method of local mutualisation of knowledge intended to be used to carry out the automatic driving of a telecommunications network.

A telecommunications network comprises a large number of links (such as physical or wireless links) and equipment (such as core or edge routers, switches, firewalls, middle boxes, terminals, etc.),

These items of equipment are responsible for many network control tasks, such as tasks concerning routing, filtering, monitoring, diagnostics, etc.

These control tasks require for their proper operation to have knowledge, i.e. contextual information of various natures concerning the links and the other items of equipment of the network (for example, the charge, the state of operation—in service/down—of links or of items of equipment, the detection of illicit traffic, etc.), and more generally on all of the objects which are handled by the processes of network management and control.

For example, in order to be able to correctly carry out a routing task, an items of equipment must know the charge or the unavailability of the links and of the other items of equipment located in the network (the knowledge of the state of a link being held by the items of equipment connected to each end of the link).

The control tasks in conventional equipment have a certain number of disadvantages for which details are provided hereinafter.

### Non-Mutualisation

With conventional equipments, the control tasks are carried out independently in relation to one another. As such, each control task collects and shows, independently of the others, the information that is necessary for it.

But the different tasks often require that the same information be collected.

This results in adversely affecting the overall performance of the network due to the many similar exchanges, and in overloading the equipment due to redundant operations.

### Knowledge Scope

Moreover, with conventional equipment, the knowledge scope is most often global. It can also entail a local physical scope, i.e. relating to physical neighbours.

As such, in many cases, each node of the network is kept informed of any modification occurring in the network, or of any local modification that affects its physical neighbours. The information distributed concerns for example the state of the links, the number of occupied memory buffers, or the capacity of the available lines.

For example, the dynamic routing of the OSPF (“Open Shortest Path First”) type requires that the changes that occur on any link to which an item of equipment is connected be passed on to the entire network.

Another example of dynamic routing is developed in US 2005/0152333 which exposes a local distribution of routing information between physical neighbours.

All of the equipment of the network is as such kept informed of a quantity of information that is more or less large, and not necessarily pertinent.

This particularity makes it difficult, even impossible to extend network architectures without modification (passing to scale) as it provokes a large quantity of exchanges between the items of equipment and involves substantial storage and processing capabilities.

### Heterogeneity of the Knowledge

With conventional equipments, due to the independence of the control tasks, the different pieces of information that are useful for the control are represented in a highly disparate manner.

This heterogeneity makes it difficult to design driving mechanisms which consist of automating the control decisions coherently or of carrying out a meta-control in a concerted manner (mechanism of controlling the control) since the different control mechanisms must take into account data of different natures according to formats that are too diverse.

US 2005/0152333 which states a local distribution of routing information between physical neighbours does not propose a mechanism of cooperation between the neighbours. Indeed, the states of the links (LSA) are simply distributed from the equipment where it is observed until a specific item of equipment is reached (referred to as a focal node). The distribution is unilateral and no information is returned to the original equipment.

Moreover, this document does not propose to mutualise the knowledge between neighbours. Indeed, the information distributed is used only by the focal nodes, with the other items of equipment only distributing it without storing or using it.

Furthermore, the data distributed is not used in its local context but returned back via the focal node. This thus entails elementary information, but not knowledge in the sense of the invention.

### PRESENTATION OF THE INVENTION

The purpose of the invention is to overcome the aforementioned disadvantages in relation with conventional equipment (non-mutualisation, global scope, heterogeneity, non-cooperation).

It proposes for this purpose a local mutualisation of knowledge (and not of information) intended to be used to feed the control tasks that an item of equipment of the network is responsible for carrying out.

More precisely, and according to a first aspect, the invention relates to a method of driving of a telecommunications network comprising items of equipment responsible for carrying out network control tasks, each item of equipment comprising a knowledge base intended to store, in the form of elements dubbed knowledge, contextual information required for the equipment to carry out the control tasks for which it is responsible, the method being characterised in that:
a logical neighbourhood is defined comprised of items of equipment of the network intended to cooperate in order to carry out the same control task, referred to as a cooperation task;
in the logical neighbourhood the knowledge stored in the different knowledge bases is mutualised, by implementing for each item of equipment of the logical neighbourhood a cooperation of said equipment with the other items of equipment of the logical neighbourhood;
in each item of equipment of the logical neighbourhood, the cooperation task is carried out by feeding it with the mutualised knowledge stored in the knowledge base of said equipment.

Certain preferred aspects, but non exhaustive, of this method are as follows:
the logical neighbourhood changes over time;
the logical neighbourhood is defined by configuration;
the logical neighbourhood is defined by subscription of one item of equipment to another;
a first item of equipment subscribes dynamically to a second item of equipment subsequent to the discovery by the first item of equipment that it has common resources and/or common constraints and/or common situations with the second equipment;
the cooperation of the items of equipment of the logical neighbourhood is regularly implemented, in order to feed the cooperation task with pertinent mutualised knowledge;
the cooperation between the items of equipment of the logical neighbourhood in order to carry out the cooperation task further comprises the establishment of a dialogue between said items of equipment;
a driving of a diagnostic of failure is implemented, with a logical neighbourhood of items of equipment provided with means of symbolic treatment adapted to the diagnostic of failure;
a driving of a defence against an attack of the denial of service type is implemented, with a logical neighbourhood comprised of edge routers of the network;
the knowledge is histograms of recipient addresses carried out using recipient addresses in the edge routers of the network, and the cooperation task consists in monitoring a threshold overflow for the number of messages intended for the same address;
the driving consists in deleting the messages in direction of an address for which said threshold has been exceeded.

According to a second and a third aspect, the invention relates to an item of equipment of a telecommunications network, respectively a telecommunications network, comprising means for implementing the method according to the first aspect of the invention.

Other aspects, purposes and advantages of this invention shall appear more clearly when reading the following detailed description of preferred embodiments of the latter, given by way of a non-exhaustive example, and made in reference to the annexed drawings wherein:

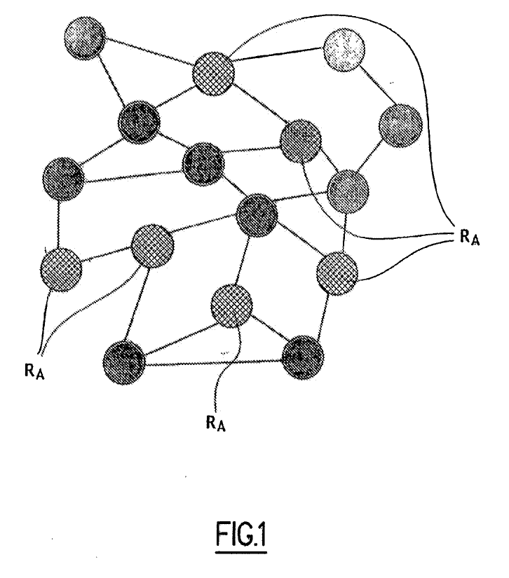

FIG. 1 is a diagram representing a logical neighbourhood corresponding to a list of routers intended to cooperate in order to carry out the same control task;

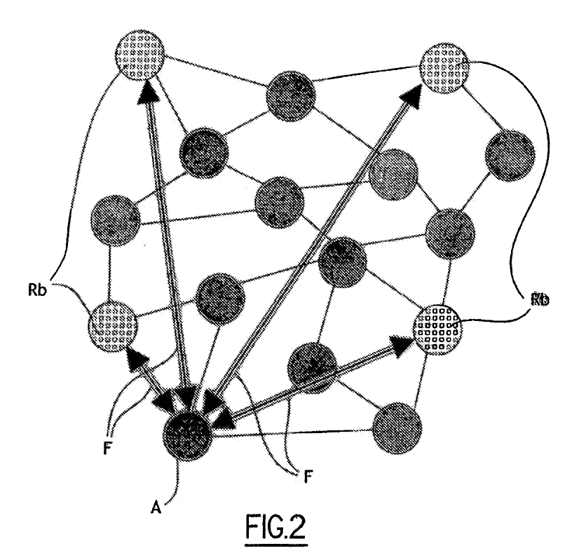

FIG. 2 is a diagram representing a logical neighbourhood corresponding to a set of edge routers, as well as to a DDOS attack crossing the edge routers of the logical neighbourhood;

FIG. 3 is a diagram representing the driving carried out in accordance with the invention in order to diagnose a failure subsequent to a fault with a link;

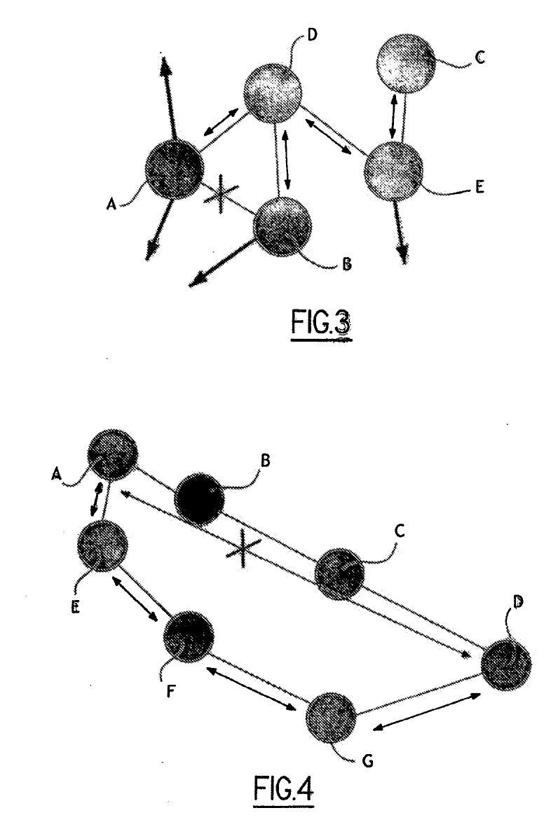

FIG. 4 is a diagram representing the driving carried out in accordance with the invention in order to diagnose a failure subsequent to the fault of a virtual circuit.

### KNOWLEDGE BASE

Within the framework of the invention, by “knowledge” is meant contextualised information, i.e. a piece of information provided with one or several attributes that vary according to the context.

For the purposes of illustration, the state of a link is a piece of information, and the state of a link to which is added attributes such as for example weights according to an internal behaviour of the item of equipment on which the link is located is knowledge. An infinite weight can in this way be allocated to the state of a link because an intelligent agent integrated into the equipment deems that the link must absolutely not be used, even if the link is entirely free.

Within the framework of the invention, all of the knowledge required by the control tasks of an item of equipment is represented in a uniform and structured manner in a knowledge base maintained in the equipment.

This base can, for example, be maintained in a format such as RDF (‘Resource Description Format’) or KIF (‘Knowledge Interchange Format’).

And as more detail will be provided in what follows, within the framework of the invention a mutualisation is implemented of the knowledge stored in the different knowledge bases of the different items of equipment of the network responsible for carrying out the same control task (also referred to as a cooperation task) and therefore belonging to the same logical neighbourhood.

The invention effectively proposes to define a logical neighbourhood of equipment comprised of items of equipment intended to cooperate in order to carry out the control task, referred to as a cooperation task. By way of example, the items of equipments of a logical neighbourhood can cooperate in order to provide a diagnostic of failure, or to cooperate in order to detect an attack of the denial of service type.

A logical neighbourhood can include an arbitrary set of items of equipment when these items of equipment desire to cooperate in order to carry out the same task. It as such corresponds to a set of items of equipment of the network included in a list of equipment.

A logical neighbourhood can be given by configuration, or be elaborated by subscription of an item of equipment to another.

A logical neighbourhood can change over time, in order to include one or several new items of equipment, or exclude one or several items of equipment. This change can in particular be carried out in order to take the state of the network into account, as well as the cooperation process between equipment of the neighbourhood.

A neighbourhood is given by configuration when a user explicitly establishes the list of items of equipment that are part of the neighbourhood.

The elaboration of the neighbourhood by subscription can be carried out by discovering the potential neighbours of an item of equipment. This elaboration is for example governed by the fact that items of equipment have common resources (such as virtual circuits), or common constraints (such as security constraints), or common situations (when for example these items of equipment are the edge nodes of a network). In such a case, an item of equipment forms its neighbourhood by subscribing dynamically to the items of equipment that it chooses. The latter are therefore informed that they are part of its neighbourhood.

Two examples of logical neighbourhoods are as follows.

In reference to FIG. 1, a logical neighbourhood groups together at instant t all of the items of network equipment (routers R_{A}) that have means of symbolic treatment (for example an inference engine) for the diagnostic of failure, and which cooperate in order to carry out the same control task of the network, i.e. a cooperation task of the diagnostic of failure type.

In reference to FIG. 2, a logical neighbourhood groups together a list of edge routers Rb of the network, which cooperate in order to carry out the same control task of the network, i.e. a cooperation task of the defence against an attack of the denial of service type.

A knowledge base can for example contain the following pieces of knowledge:
overloading of each of the items of equipment of the logical neighbourhood, with a weight attribute set by an intelligent agent installed in each item of equipment of the logical neighbourhood,
overloading of each of the links of the logical neighbourhood, with a weight attribute set by an intelligent agent installed in each item of equipment of the logical neighbourhood,
state of each of the links of the logical neighbourhood, with a service attribute (down or not),
state of each of the items of equipment of the logical neighbourhood, with a service attribute (down or not),
histogram of the most frequent recipient addresses in each of the items of equipment of the logical neighbourhood,
number of alarms on each of the items of equipment of the logical neighbourhood.

### Local Mutualisation of the Knowledge Bases

With a delimited scope corresponding to the logical neighbourhood, the knowledge stored in the different knowledge bases is mutualised by implementing for each item of equipment of the logical neighbourhood a cooperation of said equipment with the other equipments of the logical neighbourhood.

In this way, a mutualisation is carried out of the knowledge between the equipments of the logical neighbourhood, responsible for carrying out the same control task (cooperation task).

In other words, the knowledge stored in the knowledge bases of the various items of equipment of the logical neighbourhood responsible for carrying out the same control task are mutualised by cooperation between equipments of the logical neighbourhood.

An item of equipment as such implements a cooperation with the other items of equipment of the logical neighbourhood, which takes into account each piece of knowledge in its knowledge base.

This cooperation can be carried out according to different alternatives; it is preferentially carried out by a cooperation of distributed intelligent agents (each agent being installed in an item of equipment of the logical neighbourhood) having as input the mutualised knowledge of the items of equipment of the logical neighbourhood. It is specified here that the term intelligent agents means software agents capable of manipulating elaborated knowledge and of pursuing the objectives that are assigned to them by taking the changes occurring in their logical neighbourhood into account and by acting on the items of equipment.

The cooperation takes place at time intervals which can vary according the type of knowledge, items of equipment (router, firewall, converter box, application server, etc.), of the logical neighbourhood and of the state of the network.

The cooperation instances can be synchronous, in particular if new knowledge is introduced regularly, with an interval that depends on the measurements taken in order to retrieve the information that will be contextualised.

The cooperation instances can also be asynchronous, according to measurements, for example by carrying out a cooperation at each taking of measurements.

### Control Cooperation Tasks by Logical Neighbourhood

The existence of the mutualised knowledge base makes it possible to feed the control tasks with pertinent knowledge. The available knowledge is effectively very recent since it results from the regular cooperation between the items of equipment of the same logical neighbourhood. The available knowledge is furthermore adapted to the control cooperation task.

The cooperation between the items of equipment of a logical neighbourhood for the carrying out of the control task of the network referred to as a cooperation task can be implicit or explicit.

Implicit cooperation is based on the fact that the items of equipment of a neighbourhood have knowledge that is common to them (for example equipment A can be informed of the state of charge of equipment B). The control tasks make their decisions based on mutualised knowledge. By taking into account the state of their neighbours and by taking the appropriate decisions, the items of equipment therefore cooperate implicitly with one another.

Explicit cooperation is not based solely on the mutualised knowledge, and further supposes that the items of equipment establish an explicit dialogue in order to reach a decision that satisfies the items of equipment. Items of equipment of a neighbourhood can as such be led to choose a policy (pertaining for example to security) subsequent to a vote amongst all of the items of equipment of the neighbourhood, or to choose to allocate a resource (such as for example bandwidth on a link) based on a bidding mechanism between neighbours. The items of equipment can also dialogue in order to synchronise the substeps of a process such as the re-initialisation of a network.

### Driving

The automatic driving consists in implementing control tasks fed at ad hoc intervals of time, with coherent knowledge coming from mutualised knowledge bases having a scope delimited by the logical neighbourhoods.

The mutualised knowledge base feeds the control tasks of the telecommunications network in a coordinated manner since the knowledge is recent and pertinent.

This is in particular the case for the control cooperation task which is fed on each item of equipment of the logical neighbourhood corresponding by the mutualised knowledge stored in the knowledge base of said equipment.

Two examples of driving a telecommunications network are presented hereinafter. It is noted that if all of the network control tasks are fed by the mutualised knowledge bases having all of the necessary information, a global and coherent driving of the telecommunications network is obtained.

The two examples presented hereinafter relate more precisely to:
the driving of a diagnostic of failure; and
the driving of a defence against an attack of the DOS/DDOS type.

### Driving of a Diagnostic of Failure

In reference to FIG. 3, five nodes A, B, C, D and E of a network are shown, and it is supposed that the link between the nodes A and B has failed.

The knowledge base of each node contains as knowledge the state of the links: link X->Y with the “in service” or “down” attribute.

If it is supposed that the logical neighbourhood of the node C contains at least the nodes A and B, the cooperation between the nodes A, B, C of the logical neighbourhood makes it possible to mutualise the knowledge stored in the knowledge bases of each of these nodes.

In particular, this mutualisation is going to make it possible for node C to know that: link A->B “down” and that link B->A “down”. The node C logically deduces, by feeding its diagnostic of failure control task with mutualised knowledge on its logical neighbourhood, that the A-B line is down.

This simple example shows that the method according to the invention makes the diagnostic of a failure possible by implementing a cooperation between the items of equipment of the same logical neighbourhood, in order to mutualise their knowledge.

The method according to the invention is also applicable to the discovery of a virtual circuit that is down. Consider a network of which a portion is shown in FIG. 4, and suppose that the logical neighbourhood of the node F contains the nodes A, B, C and D and that the virtual circuit open between A and D passes through B and C.

The cooperation between the items of equipment of the logical neighbourhoods of F, A, B, C and D make it possible for F to know that: link A->D “down”, link D->A “down”, link A->B “in service”, link B->C “in service”, link C->D “in service”, link D->C “in service”, link C->B “in service” and link B->A “in service” and to deduce from this by feeding its diagnostic of failure control task with mutualised knowledge on its logical neighbourhood, that the virtual circuit A-D is down.

### Driving a Defence Against an Attack of the DoS/DDoS Type

The Denial of Service (DoS) is an attack that blocks, for a user, access to his machine or which delays the response time and makes it inacceptable. The DoS can occur subsequent to an attack programmed by a malicious person who intentionally overloads a resource or a system.

The DDoS (Distributed DoS) is a similar attack, coming from several sources simultaneously.

FIG. 2 shows a diagram showing a DDOS attack coming from four edge routers Rb with data streams (shown by the arrows F) converging towards the same terminal A equipment.

The logical neighbourhood is here comprised of the edge routers Rb of the telecommunications network.

The knowledge in the mutualised knowledge base used here in order to carry out a defence against an attack of the DOS/DDOS type corresponds to a histogram of recipient addresses carried out using the most frequent recipient addresses in the edge routers Rb of the telecommunications network.

The cooperation between the edge routers Rb of the network in order to mutualise their knowledge is exercised here by the exchanging of histograms between the different edge routers Rb.

Updating knowledge is carried out with a frequency of f times per second.

The control cooperation task, implemented by the edge routers Rb of the logical neighbourhood, corresponds to the monitoring of a threshold overflow for the number of messages in direction of the same recipient address. A verification of the sending addresses makes it possible in addition to consolidate the diagnostic.

The driving can then be carried out via a control action on the data streams. It entails for example to destroy the messages in direction of this address.

1. Method of driving of a telecommunications network comprising items of equipment responsible for carrying out network control tasks, each item of equipment comprising a knowledge base intended to store, in the form of elements dubbed knowledge, contextual information required so that the equipment carries out the control tasks for which it is responsible, the method being characterised in that:
a logical neighbourhood is defined comprised of items of equipment of the network intended to cooperate in order to carry out the same control task, referred to as a cooperation task;
in the logical neighbourhood the knowledge stored in the different knowledge bases is mutualised, by implementing for each item of equipment of the logical neighbourhood a cooperation of said equipment with the other items of equipment of the logical neighbourhood;
in each item of equipment of the logical neighbourhood, the cooperation task is carried out by feeding it with the mutualised knowledge stored in the knowledge base of said equipment.

2. Method set forth in claim 1, wherein the logical neighbourhood changes over time.

3. Method according to claim 1, wherein the logical neighbourhood is defined by configuration.

4. Method according to claim 1, wherein the logical neighbourhood is defined by subscription of an item of equipment to another.

5. Method set forth in claim 4, wherein a first item of equipment subscribes dynamically to a second item of equipment subsequent to the discovery by the first item of equipment that it has common resources and/or common constraints and/or common situations with the second item of equipment.

6. Method according to claim 1, wherein the cooperation of the items of equipment of the logical neighbourhood is regularly implemented, in order to feed the cooperation task with pertinent mutualised knowledge.

7. Method set forth in claim 6, wherein the cooperation between the items of equipment of the logical neighbourhood for the carrying out of the cooperation task further comprises the establishment of a dialogue between said items of equipment.

8. Method according to claim 1, wherein a driving of a diagnostic of failure is implemented, with a logical neighbourhood of items of equipment provided with means of symbolic treatment adapted to the diagnostic of failure.

9. Method according to claim 1, wherein a driving of a defence against an attack of the denial of service type is implemented, with a logical neighbourhood comprised of the edge routers of the network.

10. Method set forth in claim 9, having for knowledge histograms of recipient addresses carried out using recipient addresses in the edge routers of the network, and for cooperation task the monitoring of a threshold overflow for the number messages intended for the same address.

11. Method set forth in claim 10, wherein the driving consists in deleting the messages in direction of an address for which said threshold is exceeded.

12. Equipment of a telecommunications network characterised in that it comprises means for implementing the method according to one of claims 1 to 11.

13. Telecommunications network characterised in that it comprises means for implementing the method according to one of claims 1 to 11.
